(19) United States
(12) Patent Application Publication
(10) Pub. No.: US 2015/0043987 A1
(43) Pub. Date: Feb. 12, 2015

(54) Vehicle Wheel Strap for Auto Carriers

(71) Applicant: Ed Jacques, Howell, MI (US)

(72) Inventor: Ed Jacques, Howell, MI (US)

(21) Appl. No.: 14/455,038

(22) Filed: Aug. 8, 2014

Related U.S. Application Data
(60) Provisional application No. 61/864,338, filed on Aug. 9, 2013.

(51) Int. Cl. B61D 3/18; B60P 3/079

(52) U.S. Cl. CPC B61D 3/187; B60P 3/079
USPC 410/19

(57) ABSTRACT

Provided is an adjustable wheel strap system adapted for securing vehicles to rail cars or other auto carriers. The device comprises multi-ply rubber strap, a ratchet assembly, and tie down securement devices including one or more swivel hooks. The strap is made of multi-ply, high strength rubber with corded material in between the strap layers. The rubber material is non-abrasive and grips around over the upper half of the tire to secure it to the transporter via swivel hooks. The present invention may be retrofitted to a variety of transporters. The wheel strap system of the present invention helps prevent the shifting of the vehicle during transport, reducing the number of accidents caused by vehicle shifting on or within, or falling from, the transporters.

### CROSS REFERENCE TO RELATED APPLICATION

This application claims the benefit of U.S. Provisional Application No. 61/864,338 filed on Aug. 9, 2013, entitled “Wheel Strap System.” The above identified patent application is herein incorporated by reference in its entirety to provide continuity of disclosure.

### BACKGROUND OF THE INVENTION

1. Field of the Invention

The present invention relates to a vehicle wheel strap system comprising a tie down strap adapted for use with vehicles on rail cars and auto carriers. More specifically, the present invention includes a strap comprising a multi-ply rubber or rubber-like material, a ratchet assembly, and tie down securement devices. The rubber material prevents the strap from fraying or tearing, which commonly occurs with traditional nylon straps or other straps comprising a fabric material. The strap allows a user to secure vehicles to rail cars, auto carriers, and other transporters via fasteners, such as swivel hooks. The device eliminates the use of conventional chains and fabric straps, which helps prevent vehicle damage and accidents caused by improperly secured vehicles.

The Federal Motor Carrier Safety Administration of the United States Department of Transportation requires the use of securement devices when vehicles are transported via rail cars or other auto carriers. Generally, the vehicles are tied down and secured to the frame of the transporter. Proper securing of vehicles for transportation on rail cars or other auto carriers is essential in preventing the vehicles from shifting on or within, or falling from the rail cars or auto carriers during transport. Inadequate securing of vehicles can cause accidents, which could lead to the loss of cargo, the loss of lives, or the damage to other vehicles on the road.

Vehicle manufacturers and shippers utilize chains or straps to secure vehicles to the rail cars or auto carriers. Generally, the manufacturers and shippers require that vehicles be tied down with straps instead of chains during transit, as chains can cause damage to vehicle frames. If the chains are secured too tightly to the vehicle, the frame of the vehicle may be bent or torn from the body of the vehicle, causing permanent and unfixable damage. Bending a frame with a chain may decrease the value of the vehicle, and in some cases, the vehicle is required to be salvaged. Alternatively, the usage of improper hooks or the placement of the hooks in the wrong loop of the chains may cause further damage to the frame of the vehicle. In contrast, straps are easier to use and prevent bending of the vehicle body. Most straps, however, are made from fabric that is likely to fray, rip, or tear over time. Damaged straps provide inadequate securement as it lacks the strength to keep the vehicles from moving around during transport, causing damage to vehicles and increasing maintenance costs.

The present invention improves upon tie down straps for vehicles that can be quickly installed on a variety of transporters such as car haul equipment or bi-level rail cars without causing damage to the vehicles thereto and without requiring a modification of the transporters to install the strap system. The device comprises multi-ply rubber strap having corded material between the layers, a ratchet assembly, and tie down securement devices including at least one swivel hook. The strap is made of multi-ply, high strength rubber or rubber-like material, and is long enough to wrap around a portion of a vehicle. Though traditional straps are positioned around only a small portion of a vehicle tire, the multi-ply rubber strap of the present invention wraps around over the half of the tire. The strap further includes at least one swivel hook, wherein the hook is preferably hooked onto at least one of several anchor points on the transporter. The straps are adjusted using a ratchet system disposed at one end of the strap. The present invention provides a convenient method to prevent the vehicle from shifting on or within, or falling from, the rail cars or auto carriers.

2. Description of the Prior Art

Devices have been disclosed in the prior art that relate to a tie down strap for use with vehicles on rail cars and auto carriers. Some of these devices disclose a tie down strap that includes a two way tie down assembly with a ratchet. Other known devices include a strap with multiple cleats that engage the treads on the tires to secure the vehicle in position during transit. While these devices disclosed in the prior art include straps for use with vehicles on rail cars and auto carriers, these devices do not utilize a heavy duty two-ply rubber material, which would prevent damage to the vehicles. Similarly, the disclosed prior art patents does not utilize a ratchet assembly as an embodiment of a vehicle securement means. Accordingly, these prior art devices have several known drawbacks.

U.S. Pat. No. 4,044,691 to Kilgus discloses a vehicle tie down system for rail cars. The Kilgus device provides a two-point tie down system where the front and rear of the same side of a vehicle is secured. The Kilgus device includes a tie down assembly having a double chain in a triangular configuration, a ratchet assembly, and a pivotable hook assembly. The double chain in a triangular configuration is adapted to restrain a vehicle at the point of engagement when it is secured to a rail car. As the chain is tensioned using a ratcheting device, the vehicle is pulled closer to the rail, the apex of the triangle moves closer to what would be its base. While the Kilgus device provides a tie down system for a vehicle, the triangular double chain assembly is injurious to the vehicle when it is subjected to impacts during transportation. The present invention provides a heavy duty two-ply rubber belt material prevent any damage to the vehicle while securing the vehicle in place.

Similarly, U.S. Pat. No. 5,108,237 to Zankich provides a tie down strap assembly for retaining a vehicle during transportation. The strap assembly of Zankich includes one or more cleat members slidably installed on the strap. The cleat members have projections that engage the tread of a tire of a vehicle to be retained in position for transportation on a rail car or other transporter. The opposite ends of the strap assembly are secured to the body of the transporter. A ratchet may be installed with the strap to tighten the strap against the vehicle tire. U.S. Pat. No. 7,195,433 to Cash discloses a retractable tie down system for securing a vehicle to a cargo vehicle. The retractable tie down includes a retractor assembly fixed to the outer surface of a work vehicle, a belt with one end connected to the retractor assembly, and a coupling connected to the other end of the belt. Though devices such as these utilize a strap rather than a chain, conventional straps have limited use in that it is often frayed and torn after repeated usage.

Like the Zankich device, U.S. Pat. No. 6,494,651 to Zhan provides a rail car loan securement apparatus. The device of Zhan includes an anchor, a mounting brace, a top plate, and a plurality of load securement strap. The mounting brace is attachable to a rail car frame. The adjustable straps are secured to anchor with a B-shaped hook device. The straps are tensioned using a combination adjuster and toggle. While the straps may be readily mounted to retain cargo, the Zhan device is limited to use with a mounting brace which is inconvenient to transport and cumbersome to install, and require the use of permanent installations or fasteners that can cause damage to a rail car or a vehicle being transported. The present invention includes a compact and portable tie down system that can be easily retrofitted to a variety of auto carriers, providing convenience to the user.

U.S. Published Patent Application 2012/0246883 to Zinni discloses a device for securing cargo comprising a tie down binding strap with at least two different types of tightening mechanisms. A centrally located rotary tightening mechanism includes a hand turnable female fitting having threads engageable with a threaded male fitting that allows adjustment. The invention further includes an intermediate section includes a strap tightening mechanism, and a fastening end attached thereto. The fastening ends are interchangeable with different types that can be operatively connected to a bearing clip operatively connected to the rotary tightening mechanism. While the device of Zinni provides versatility and secures cargo having different shapes, the device of Zinni does not comprise a rubber-like binding strap material, which is much more durable compared to traditional straps.

While the devices in the art are well adapted for their given requirements and fulfill a need, they share common drawbacks. These devices are not durable over repeated use, and do not minimize damage to the vehicles during transportation. Furthermore, these devices are bulky and inconvenient to install. The present invention utilizes a portable and compact design that is quickly installable on a rail car or other auto carrier while providing means to support a mounted car to prevent the tires of the vehicle from moving backward. The present invention substantially diverges in design elements from the prior art and consequently it is clear that there is a need in the art for an improvement to existing tie down system for vehicles. In this regard, the instant invention substantially fulfills these needs.

### SUMMARY OF THE INVENTION

In view of the foregoing disadvantages inherent in the known types of wheel strap devices for vehicles now present in the prior art, the present invention provides a new improvement to wheel strap devices wherein the same can be utilized for securing vehicles to a rail car or other auto carrier, while minimizing damage to the vehicles during transportation.

It is therefore an object of the present invention to provide a new and improved wheel strap device for vehicles that has all of the advantages of the prior art and none of the disadvantages.

It is another object of the present invention to provide a new and improved wheel strap device for vehicles having heavy duty a multi-ply rubber strap adapted to wrap around a tire of a vehicle to secure the vehicle to an auto carrier or a rail car.

Another object of the present invention to provide a new and improved wheel strap device for vehicles having a ratchet system that enables a user to adjust the length of the multi-ply strap around a vehicle tire for both tightening and loosening.

Still another object of the present invention is to provide a new and improved wheel strap device for vehicles having a portable and compact design that is quickly installable on a rail car or other auto carrier while providing means to support a mounted vehicle to prevent the vehicle tires from moving backward.

Yet another object of the present invention is to provide a new and improved wheel strap device for vehicles that is durable over repeated use and minimizes damages to the vehicles during transportation.

Yet another object of the present invention is to provide a new and improved wheel strap device for vehicles that may be retrofitted to a variety of existing rail cars or other auto carriers.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of the wheel strap system of the present invention.

FIG. 2 is a view of a swivel hook assembly of the present invention, wherein a fitting portion of the swivel hook assembly is connected to one end of a multi-ply rubber strap and the hook portion of the swivel hook assembly is connected to a vehicle transporter.

FIG. 3 is a rear view of a vehicle tire mounted on a vehicle transporter and tied down in place by a multi-ply rubber strap and a swivel hook of the present invention.

FIG. 4 is a view of the ratchet system of the present invention, including a cargo lashing strap, an end fitting, and a ratchet buckle.

### DETAILED DESCRIPTION OF THE INVENTION

Reference is made herein to the attached drawings. Like reference numerals are used throughout the drawings to depict like or similar elements of the wheel strap system. For the purposes of presenting a brief and clear description of the present invention, the preferred embodiment will be discussed as used for a wheel strap system securing a vehicle. The figures are intended for representative purposes only and should not be considered to be limiting in any respect.

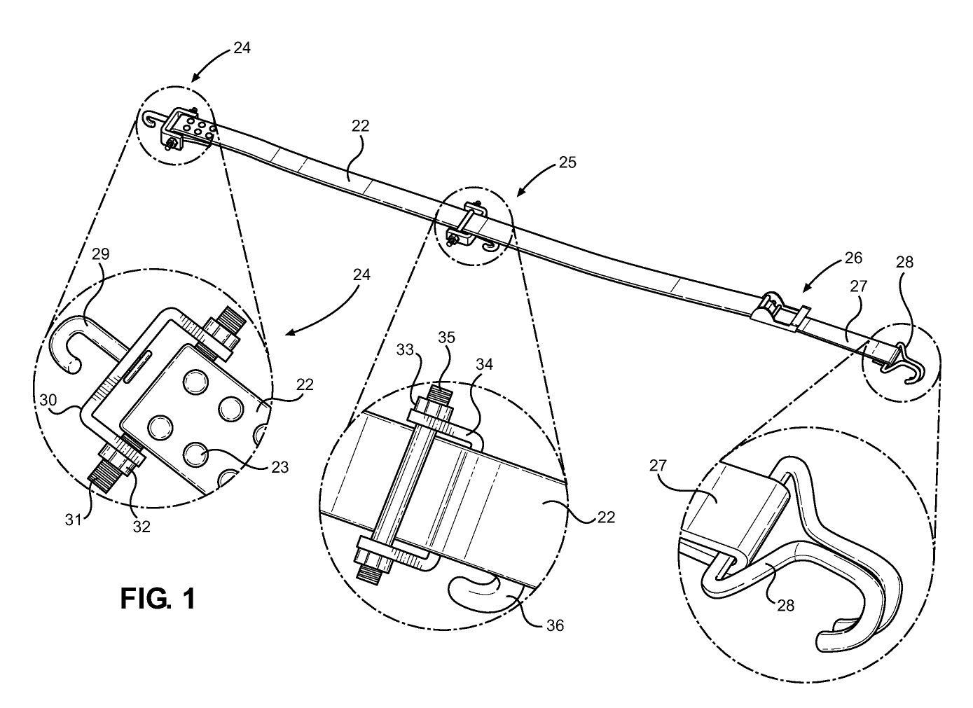

Referring now to FIG. 1, there is shown a perspective view of the wheel strap system of the present invention. The present invention comprises a tie down strap 22 adapted to secure a vehicle tire to a transporter such as a rail car or other auto carrier. The strap 22 comprises a multi-ply, high strength rubber with corded material in between the layers. The rubber or rubber-like material used for the strap 22 provides a high-friction grip when the strap 22 is positioned around the vehicle tire. This feature prevents vehicles from coming loose in transit from improper strap material. The strap 22 may vary in length to ensure that it has sufficient capacity to support vehicles being transported.

The strap 22 includes a terminal end and a working end. The terminal end includes a front swivel hook assembly 24 comprising metal or other suitable material. The front hook assembly 24 comprises a U-shaped structure 30 having a middle portion, wherein the middle portion of the U-shaped structure 30 includes a swivel hook 29 having a curved hook tip. The U-shaped structure 30 further includes two terminal ends and a set of apertures disposed thereon. A rod 31 is inserted through the apertures, and secured with a fastener 32. In the illustrated embodiment, the fastener 32 comprises a nut. Accordingly, the rod 31 may have threading along its outer surface to accept the nut. The strap 22 is threaded between the rod 31 and the U-shaped structure 30 and folded onto itself and form a closed loop after being inserted into the U-shaped structure 30. The closed loop is secured with a set of fasteners 23, such as screws, snap fasteners, or the like.

A rear swivel hook assembly 25 is positioned between the terminal and working end of the strap 22, and is adapted to slide freely therebetween along the length of the strap 22. The rear swivel hook assembly 25 is substantially similar to the front swivel hook assembly 24, wherein the rear swivel hook assembly 25 includes a U-shaped structure 34 having an aperture disposed at each of its terminal ends and a rod 35 inserted therethrough. The rod 35 is secured in place between the U-shaped structure 34 via a fastener 33, such as a nut. When the rod 35 is secured in place, the rear swivel hook assembly 25 creates an entry way to thread the working end of the strap 22 therethrough. The rear swivel hook assembly 25 is adapted to create a tension point behind a vehicle tire on a vehicle transporter 21 via a hook 36.

Once the working end of the strap 22 is threaded through the rear swivel hook assembly 25, the working end of the strap 22 is removably connected to a ratchet system 26. The ratchet system 26 may comprise any suitable ratcheting means. For example, the ratchet system 26 may comprise a one-way ratcheting mechanism that rotatably drives the socket in one direction and ratchets when rotated in the other direction to allow for relative rotation between the lever arm and the socket element, such as via any known ratchet mechanisms or the like. Optionally, the ratcheting mechanism may comprise a two-way ratcheting mechanism that selectively rotatably drives the socket in a selected direction and ratchets when rotated in the other direction to allow for relative rotation between the lever arm and the socket element. The ratchet system 26 is connected to a cargo lashing strap 27, wherein a first end of the cargo lashing strap 27 is secured to the ratchet system 26 in a closed loop. A second end of the cargo lashing strap 27 includes a hook 28. The second end of the cargo lashing strap 27 may also be secured to the hook 28 by folding onto itself to form a closed loop around the hook 28.

When in use, the wheel strap system of the present invention is positioned in place prior to transporting vehicles. Accordingly, when the vehicles are mounted on a vehicle transporter, the swivel hooks 24, 25 and the hook 28 are removably secured onto respective anchor points on the transporter. The multi-ply rubber material 22 is tightened around each vehicle tire using the ratchet system 26 until a proper tension is achieved. This prevents a backward motion of the item being secured. In this way, the present invention anchors a vehicle to hauling equipment during transit.

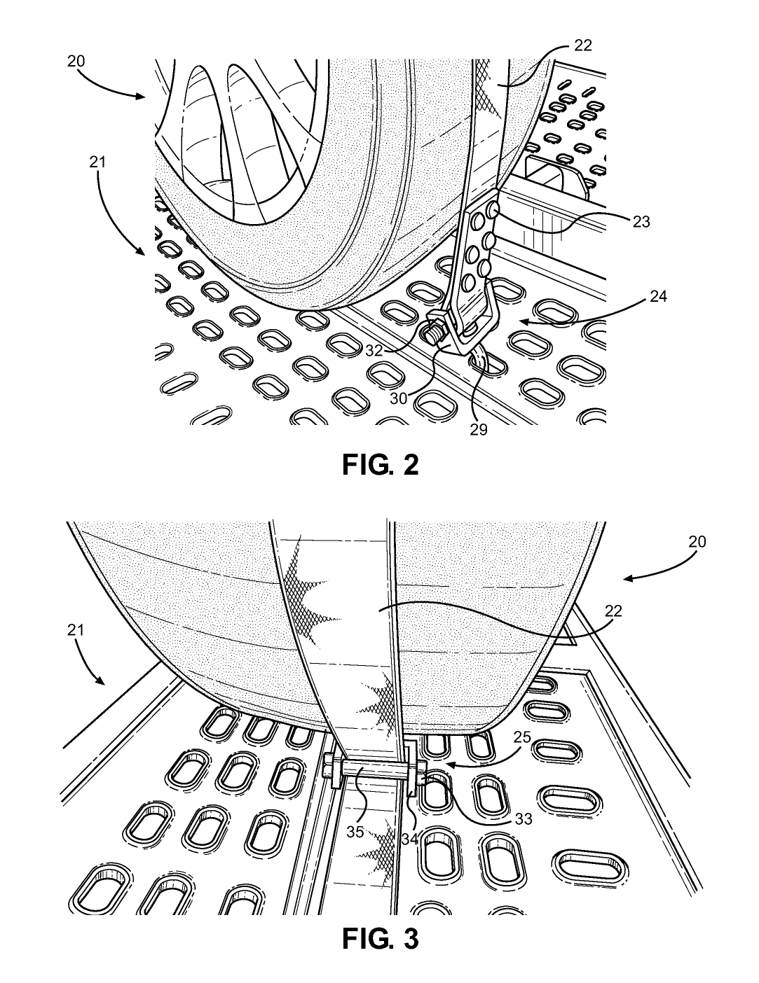

Referring now to FIG. 2, there is shown a perspective view of the wheel strap system of the present invention positioned around a vehicle tire 20. The front swivel hook assembly 24 of the present invention allows a user to position the multi-ply rubber strap 22 around a vehicle tire 20 and anchor down the tire 20 mounted on a vehicle transporter 21. In use, the strap 22 secures approximately 60% of the vehicle tire 20, which provides significantly more support than traditional straps, which only secures approximately 10% of the tire during transit.

The front swivel hook assembly 24 includes a hook 29, a U-shaped structure 30 having two terminal ends, and a set of apertures disposed therein. A rod 31 is inserted therethrough, and secured with a fastener 32, forming an entry adapted to receive a terminal end of the multi-ply rubber strap 22. The multi-ply rubber strap 22 is threaded through the U-shaped structure 30 and folded onto itself and form a closed loop around the rod 31. In the illustrated embodiment, a plurality of fasteners 23 keeps the loop closed, but the loop may also be sewn closed in alternate embodiments.

The hook 29 of the present invention is swivably attached to the middle portion of the U-shaped structure 30. The hook 29 is movable radially relative to the axis of rotation, which provides flexibility to easily reposition or remove the hook 29 when in place. When in use, the hook 29 is anchored to the vehicle transporter 21 in front of the vehicle tire 20 by looping through one or more apertures disposed on the transporter 21 surface adapted to support loaded vehicles. The hook 29 is anchored near the bottom portion of the vehicle tire 20 to maximize the contact area between the tire 20 and the strap 22. Increased contact between the tire 20 and the strap 22 increases stability, permitting the device to minimize the shifting of the vehicles during transport.

Referring now to FIG. 3, there is shown a view of the rear swivel hook 25 of the present invention secured at an anchor point behind a vehicle tire 20. The rear swivel hook 25 includes a hook tip, a U-shaped structure 34 having two terminal ends, and a set of apertures disposed therein. A rod 35 is inserted therethrough, and secured with a fastener 33, forming an entry adapted to receive the working end of the multi-ply rubber strap 22. The working end of the multi-ply rubber strap 22 is threaded through the U-shaped structure 34 and anchored onto the vehicle transporter 21 to create a tension point. Thereafter, the working end of the strap 22 is fed into the ratchet buckle to be wrapped around the axle.

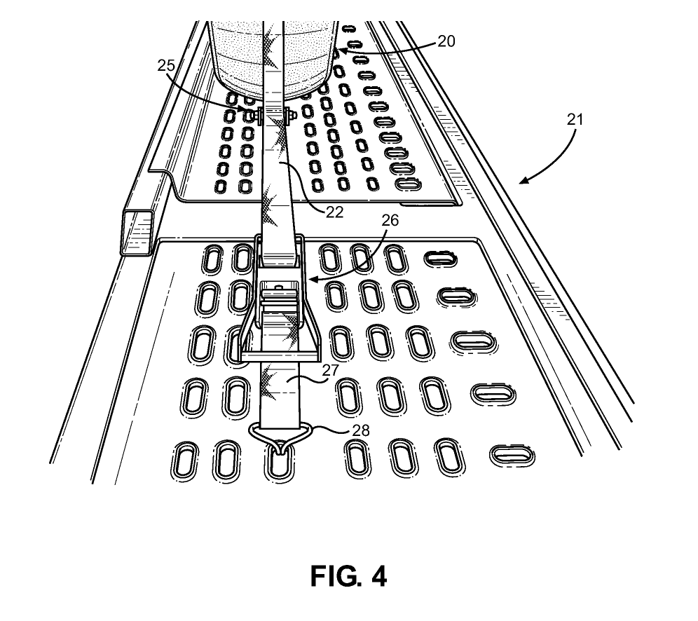

Referring now to FIG. 4, there is shown a ratchet system 26 of the present invention positioned behind the rear swivel hook 25. The ratchet system 26 is removably connected to the working end of a multi-ply rubber strap 22. The ratchet provides means to cinch the multi-ply rubber strap 22 and a cargo lashing strap 27 tightly against the transporter 21 and secure the device around a vehicle tire 20. The ratchet system 26 prevents the tire 20 from moving backward, but aids in moving the tire 20 forward in a continuous motion. The ratchet system 26 comprises three main elements: a ratchet buckle, a cargo lashing strap 27, and a hook 28.

The ratchet buckle includes a linear passageway, an axle, a ratchet handle, and a release handle. The axle is constructed to slidably receive the working end of the multi-ply rubber strap 22. The working end of the multi-ply rubber strap 22 is threaded through the axle and pulled back towards itself in the direction it entered the axle. To tighten the rubber strap 22 around the vehicle tire 20, the ratchet handle is raised and lowered to engage the axle, which causes the working end of the strap 22 to wrap around the axel and tightened.

The ratchet buckle further includes a round or linear rack with teeth and a spring-loaded pivoting gear that engages the teeth. The teeth are uniform, but asymmetrical, with each tooth having a moderate slope on one edge and a much steeper slope on the other edge. When the ratchet handle is raised and lowered to engage the axle, the teeth move in a forward direction, and the pivoting gear easily slides up and over the gently sloped edges of the teeth, with a spring forcing it into the depression between the teeth as it passes the tip of each tooth. Accordingly, the working end of the rubber strap 22 is fed into the buckle and wrapped around the axle. When the teeth move in the backward direction, however, the pivoting gear will catch the rubber strap 22 against the steeply sloped edge of the first tooth it encounters, thereby locking it against the tooth and preventing any further motion in that direction. As such, the pivoting gear aids in securing the tire in the appropriate position before and during transport. Once the rubber strap 22 is properly tensioned, the excess portion of the rubber strap 22 may be fastened to the transporter 21 or rolled and tucked away to keep the excess portion of the strap 22 out of the way.

To loosen or remove the rubber strap 22 after use, a release handle is pulled and held as the ratchet handle is opened. When the release handle is pulled, the pivoting gear is pulled out of one of the steeply sloped edge of a tooth, and is locked the pulled out position as the ratchet handle is opened. This allows the rubber strap 22 to move freely around the axle without catching onto the pivoting gear, allowing the user to loosen the rubber strap 22 or pull it out of the axle.

The linear passage way of the ratchet buckle is constructed to slidably receive a cargo lashing strap 27 having a first and second terminal ends. The first terminal end of the cargo lashing strap 27 is threaded through the linear passageway of the ratchet buckle and folded onto itself to form a closed loop. The loop may be sewn closed or secured with one or more fasteners. The second terminal end of the cargo lashing strap 27 includes a hook 28 attached thereto. In the illustrated embodiment, the hook 28 may comprise a J-hook, but alternate embodiments may include an S-hook or other hooks adapted to attach to a desired anchor point disposed a vehicle transporter 21 surface.

Overall, the present invention is designed to increase the portability and securement of the vehicles being transported by providing a wheel strap system that can be utilized with existing rail cars and auto carriers. The present invention provides a highly durable strap suitable for securing vehicle tires over repeated uses. The ratchet device positioned behind the vehicle tire prevents the vehicle from rolling backwards, while the adjustable end comprising a swivel hook loops onto an aperture disposed on a transporter surface. The present invention is ideal for use by manufacturers and vehicle shippers, but it is also suitable for personal use.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An adjustable wheel strap system adapted for securing a vehicle on a transporter, comprising:
a multi-ply strap, comprising a corded material disposed between layers of said multi-ply strap, said multi-ply strap comprising an elongated length with a terminal end and a working end;
a front swivel hook assembly connected to said multi-ply strap terminal end; and
a strap tensioner means adapted to adjust said length of said multi-ply strap, said strap tensioner being removably connected to said working end of said multi-ply strap.

2. The wheel strap system of claim 1, wherein said strap tensioner means comprises a ratchet device.

3. The wheel strap system of claim 2, wherein said ratchet device further comprises:
a cargo lashing strap having a first terminal end and a second terminal end;
said first terminal end connected to a hook;
said second terminal end connected to said ratchet device.

4. The wheel strap system of claim 1, further comprising a rear swivel hook assembly adapted to slide freely between said multi-ply strap terminal end and said multi-ply strap working end along said length of said multi-ply strap.

5. The wheel strap system of claim 1, wherein said corded material comprises rubber.

6. The wheel strap system of claim 1, wherein said front swivel hook assembly and said rear swivel hook assembly each further comprises:
a U-shaped structure having a middle portion, a first and second end with a plurality of apertures therethrough;
a rod inserted through said apertures and secured via a fastener, forming an entry adapted to accept said multi-ply strap therethrough; and
a hook having a hook bend with a hook tip and an attachment end, said hook attachment end swivably attached to said middle portion of said U-shaped structure;
said hook adapted to be securable to an anchor point.

7. The wheel strap system of claim 6, wherein said terminal end of said multi-ply strap is threaded through said entry and folded onto itself and connected together to form a closed loop, wherein said rod lies within said closed loop.
